(19) United States
(12) Patent Application Publication
(10) Pub. No.: US 2008/0104417 A1
(43) Pub. Date: May 1, 2008

(54) SYSTEM AND METHOD FOR FILE ENCRYPTION AND DECRYPTION

(76) Inventors: Ernest H. Nachtigall, Brampton (CA); Marilyn F. Allmond, Gaithersburg, MD (US)

Correspondence Address: HOFFMAN, WARNICK & D'ALESSANDRO LLC, 75 STATE ST, 14 FL, ALBANY, NY, 12207, US

(21) Appl. No.: 11/552,587

(22) Filed: Oct. 25, 2006

(51) Int. Cl. G06F 12/14; H04L 9/32; G06F 11/30; H04L 9/00; H04L 9/30; H04K 1/00

(52) U.S. Cl. 713/193; 713/176; 380/30

(57) ABSTRACT

There is disclosed a system and method for file encryption and decryption. In an embodiment, a method of encrypting a file on backup media involves encrypting clear data using a data encryption key applied to a data encryption algorithm and outputting encrypted data; storing the encrypted data on the backup media; encrypting the data encryption key using a reference cryptographic key applied to a key encryption algorithm and outputting an encrypted data encryption key; and storing the encrypted data encryption key and reconstitution data in a header of the backup media. The encrypted data may be subsequently decrypted by identifying the reference cryptographic key using the reference cryptographic key name; applying the reference cryptographic key to a key decryption algorithm to decrypt the encrypted data encryption key; and applying the decrypted data encryption key to a data decryption algorithm to decrypt the encrypted data.

### COPYRIGHT NOTICE

A portion of the disclosure of this patent document contains material which is subject to copyright protection. The copyright owner has no objection to the facsimile reproduction of the patent document or the patent disclosure, as it appears in the United States Patent and Trademark Office patent file or records, but otherwise reserves all copyright rights whatsoever.

### FIELD OF THE INVENTION

The present invention relates to systems and methods for file encryption and decryption.

### BACKGROUND OF THE INVENTION

With today's information technology (IT) systems and operations, there is often a need to create backup files for archival purposes and to transfer files securely from one location to another. Such files are often stored on portable data processor readable media such as, for example, magnetic data tapes or cartridges, and writable or rewritable optical disks. These media may sometimes be misplaced or become lost in transit to another location. Files stored on these media may contain highly sensitive information such as customer names, addresses, bank account numbers, account balances, etc. and may need to be protected from unauthorized access.

Various solutions for encrypting backup files have been proposed but may exhibit certain limitations. For example, some encryption solutions may require users to retain private keys, or both private and public keys, for each piece of media storing encrypted data. If the keys are not well managed, retrieval may become difficult or impossible after years or decades have passed.

What is needed is an improved method and system for file encryption and decryption that may overcome some of these limitations.

### SUMMARY OF THE INVENTION

The present invention relates to an improved system and method for file encryption and decryption.

In an aspect of the invention, there is provided a method of encrypting a file on backup media, comprising: encrypting clear data using a data encryption key applied to a data encryption algorithm and outputting encrypted data; storing the encrypted data on the backup media; encrypting the data encryption key using a reference cryptographic key applied to a key encryption algorithm and outputting an encrypted data encryption key; and storing the encrypted data encryption key and reconstitution data in a header of the backup media.

In an embodiment the method further comprises storing the reference cryptographic key in a reference cryptographic key data set.

In another embodiment the method further comprises storing in the reconstitution data the reference cryptographic key name.

In another embodiment the method further comprises storing in the reconstitution data the clear data characteristics and the encrypted data characteristics.

In another embodiment the method further comprises subsequently decrypting the encrypted data as follows: reading the reference cryptographic key name from the reconstitution data; identifying the reference cryptographic key in the reference cryptographic key data set using the reference cryptographic key name; applying the reference cryptographic key to a key decryption algorithm to decrypt the encrypted data encryption key; and applying the decrypted data encryption key to a data decryption algorithm to decrypt the encrypted data.

In another embodiment the method further comprises utilizing the clear data characteristics and the encrypted data characteristics stored in the reconstitution data to decrypt the encrypted data.

In another embodiment the method further comprises securing the reference cryptographic key in cryptographic hardware during decryption of the data encryption key.

In another aspect of the invention, there is provided a system for encrypting a file on backup media, comprising: a data encryption algorithm module configured to encrypt clear data using a data encryption key and to output encrypted data; encrypted data storing means for storing the encrypted data on the backup media; a key encryption algorithm module configured to encrypt the data encryption key using a reference cryptographic key; and header storing means for storing the encrypted data encryption key and reconstitution data in a header of the backup media.

In an embodiment, the system further comprises a reference cryptographic key data set storing the reference cryptographic key.

In another embodiment, the storing means is configured to store the reference cryptographic key name in the reconstitution data.

In another embodiment, the storing means is configured to store the clear data characteristics and the encrypted data characteristics in the reconstitution data.

In another embodiment, the system is configured to subsequently decrypt the encrypted data, the system further comprising: reading means for reading the reference cryptographic key name from the reconstitution data stored in the backup media header; identifying means for identifying the reference cryptographic key in the reference cryptographic key data set using the reference cryptographic key name; a key decryption algorithm module configured to decrypt the encrypted data encryption key by applying the reference cryptographic key; and a data decryption algorithm module configured to decrypt the encrypted data by applying the decrypted data encryption key.

In another embodiment, the data decryption algorithm module is further configured to utilize the clear data characteristics and the encrypted data characteristics stored in the reconstitution data.

In another embodiment, the key decryption algorithm module is further configured to decrypt the data encryption key while securing the reference cryptographic key in the cryptographic hardware.

In another aspect of the invention, there is provided a data processor readable medium storing data processor code that when loaded into one or more data processors adapts the processors to provide a method of encrypting data on backup media, the data processor readable medium comprising: code for encrypting clear data using a data encryption key applied to a data encryption algorithm and outputting encrypted data; code for storing on the backup media; code for encrypting the data encryption key using a reference cryptographic key applied to a key encryption algorithm and outputting an encrypted data encryption key; code for storing the encrypted data, the encrypted data encryption key and reconstitution data in a header of the backup media.

In another embodiment, the data processor readable medium further comprises code for storing the reference cryptographic key in a reference cryptographic key data set.

In another embodiment, the data processor readable medium further comprises code for storing in the reconstitution data the reference cryptographic key name.

In another embodiment, the data processor readable medium further comprises code for storing in the reconstitution data the clear data characteristics and the encrypted data characteristics.

In another embodiment, the data processor readable medium further comprises code for subsequently decrypting the encrypted data, including: code for reading the reference cryptographic key name from the reconstitution data; code for identifying the reference cryptographic key in the reference cryptographic key data set using the reference cryptographic key name; code for applying the reference cryptographic key to a key decryption algorithm to decrypt the encrypted data encryption key; and code for applying the decrypted data encryption key to a data decryption algorithm to decrypt the encrypted data.

In another embodiment, the data processor readable medium further comprises code for utilizing the clear data characteristics and the encrypted data characteristics stored in the reconstitution data to decrypt the encrypted data.

In another embodiment, the data processor readable medium further comprises code for securing the reference cryptographic key in cryptographic hardware during decryption of the data encryption key.

These and other aspects of the invention will become apparent from the following more particular descriptions of exemplary embodiments.

### BRIEF DESCRIPTION OF THE INVENTION

These and other features of this invention will be more readily understood from the following detailed description of the various aspects of the invention taken in conjunction with the accompanying drawings.

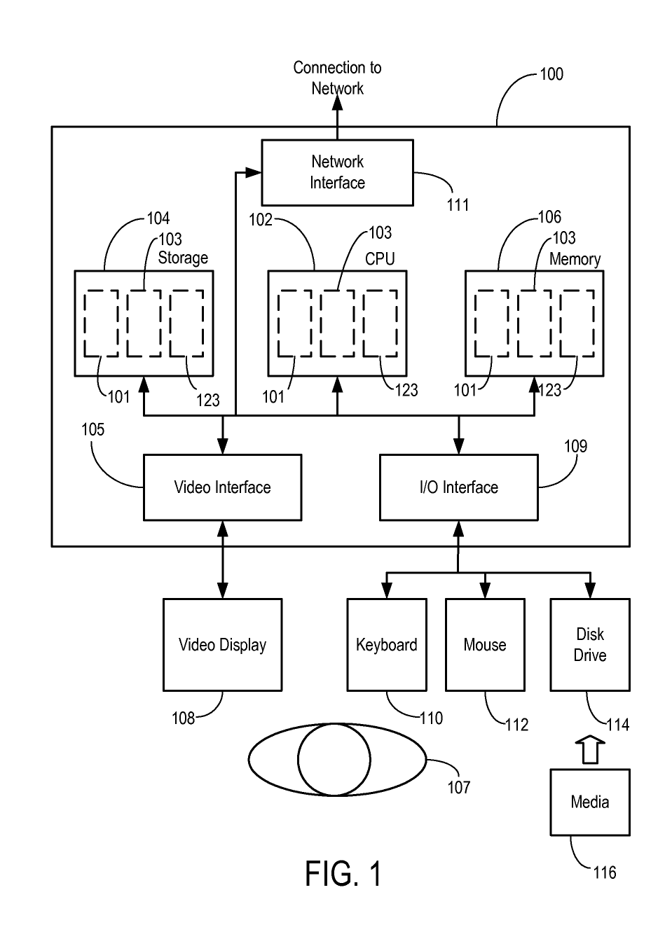

FIG. 1 shows a generic data processing system that may provide a suitable operating environment.

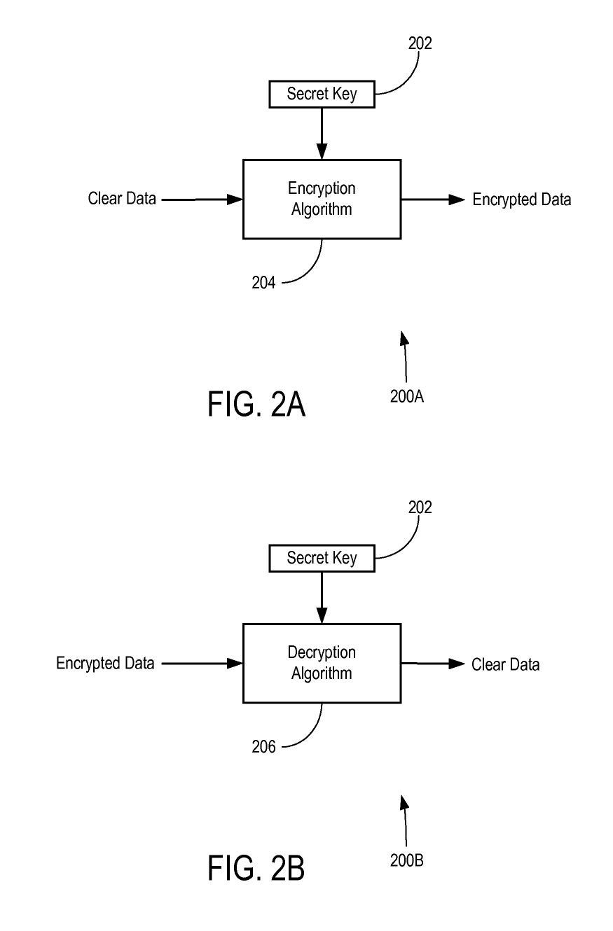

FIGS. 2A and 2B show a schematic block diagram of illustrative components of a private key encryption system.

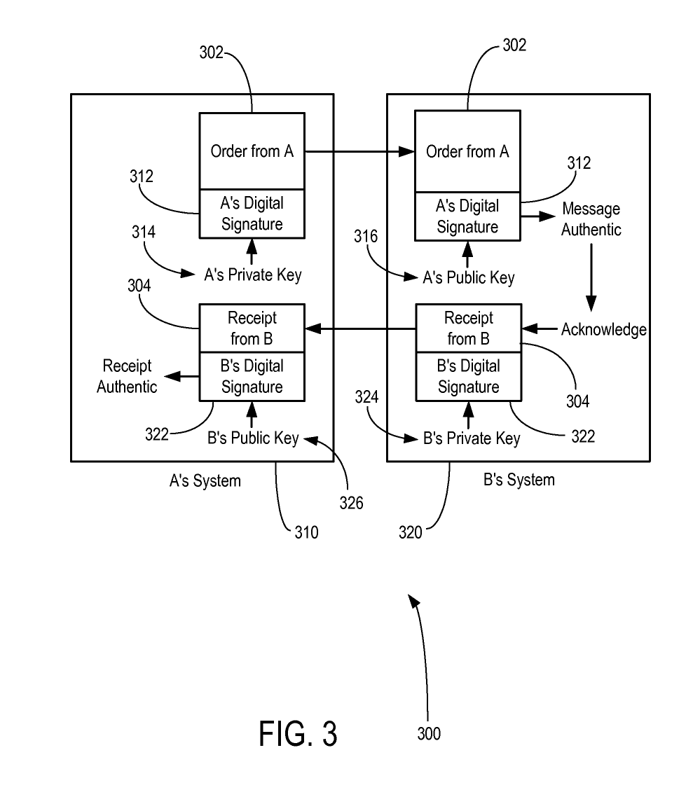

FIG. 3 shows a schematic block diagram of illustrative components of a public key/private key encryption system.

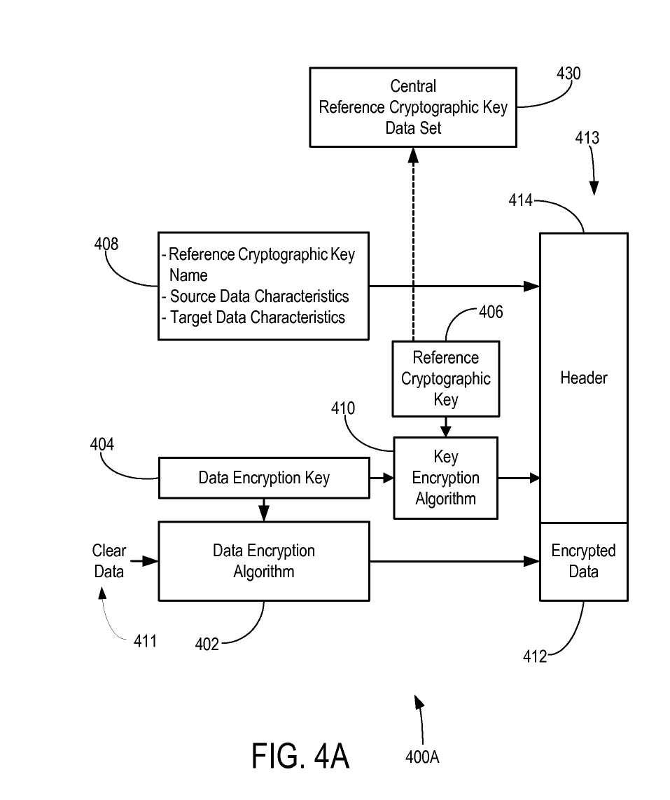

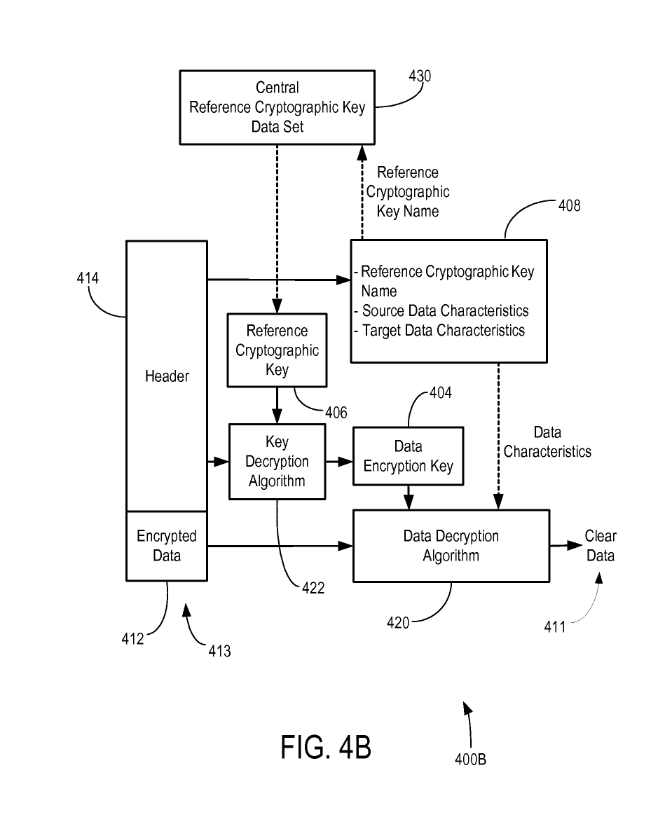

FIG. 4 shows schematic block diagrams of illustrative components of a multi-level encryption/decryption system in accordance with an embodiment of the present invention;

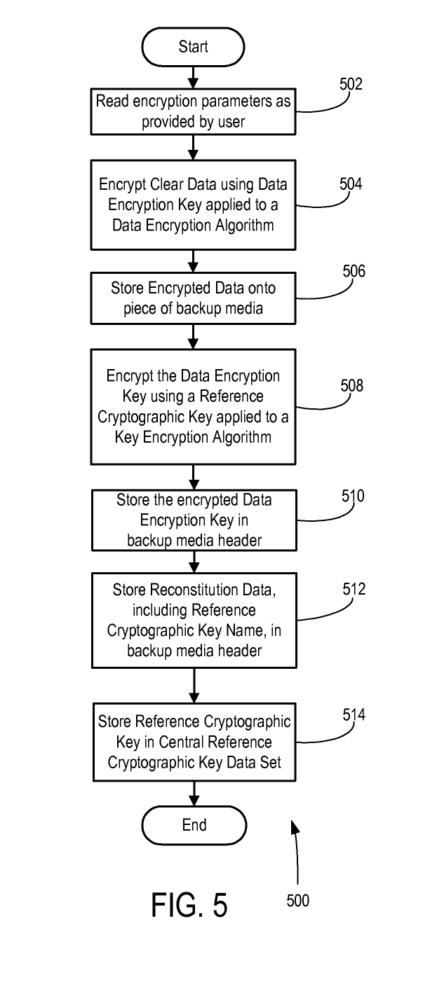

FIG. 5 shows a flowchart of an illustrative method in accordance with an embodiment of the present invention;

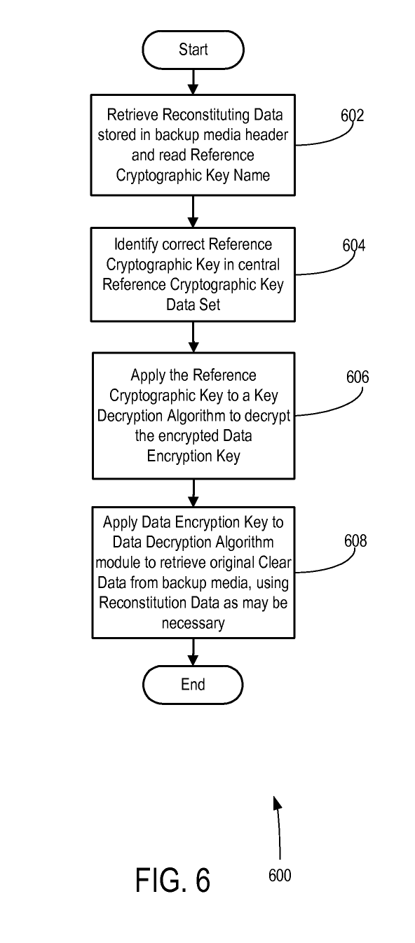

FIG. 6 shows a flowchart of an illustrative method in accordance with another embodiment of the present invention.

### DETAILED DESCRIPTION OF THE INVENTION

As noted above, the present invention relates to an improved system and method for file encryption and decryption.

The invention may be practiced in various embodiments. A suitably configured data processing system, and associated communications networks, devices, software and firmware may provide a platform for enabling one or more embodiments. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (“GUI”) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown). The particular configurations shown by way of example in this specification are not meant to be limiting. For example, in a mainframe environment, the video interface 105, video display 108, keyboard 110 and mouse 112 may be provided at a workstation operatively connected to a mainframe (not shown).

Now referring to FIGS. 2A and 2B, shown are schematic block diagrams of illustrative components of a private key encryption system 200A. As shown in FIG. 2A, using a secret key 202, a clear data (i.e. unencrypted data) input may be encrypted at block 204 using an encryption algorithm. The output from block 204 is an encrypted version of the clear data that may be stored on backup media (e.g. magnetic data tapes or cartridges, writable or rewritable optical disks). In order to access the encrypted data on the media, the encrypted data is provided as an input to block 206 and the secret key 202 is used in conjunction with the decryption algorithm at block 206 to output the original clear data.

Shown in FIG. 3 is a schematic block diagram of illustrative components of another encryption system 300 using public key/private key cryptography. As shown, Party A may want to send certain order data 302 securely to Party B and in turn receive an order receipt 304. An order originating from Party A's system 310 may include Party A's digital signature 312 and the order data 302 may be encrypted using Party A's private key 314. At Party B's system 320, upon verification that the order data 302 from Party A is authentic, Party B's system 320 may receive Party A's encrypted order data 302 and decrypt the order data 302 using Party A's public key 316.

Party B may then acknowledge receipt of the order data 302 by generating the order receipt 304, which now contains Party B's digital signature 322. The order receipt 304 may now be encrypted using Party B's private key 324, and upon receiving the order receipt 304 at Party A's system 210, the order receipt 304 may be decrypted using Party A's private key 326.

As will be appreciated by those skilled in the art, the encryption systems shown in FIGS. 2A, 2B and 3 require that either a private key, or a private and public key, be maintained in order to decrypt and recover datasets. If there are many pieces of media, maintaining the private keys or private key/public key combinations for each piece of media may become difficult.

In order to address this problem, the present invention provides a multi-level encryption system in which there is one or perhaps a few Reference Cryptographic Keys that may be used to protect and reference many unique Data Encryption Keys stored together with the encrypted data on the backup media. As an example, using a Reference Cryptographic Key having 168 bits in length, each reference cryptographic key may be used to protect and reference some 2168 unique Data Encryption Keys. The unique Data Encryption Keys may be stored, for example, as an encrypted key in a clear header on each piece of backup media.

Now referring to FIG. 4A, shown is a schematic block diagram of illustrative components of a multi-level encryption system 400A in accordance with an embodiment of the present invention. As shown, a Data Encryption Algorithm module 402 may be configured to utilize a Data Encryption Key 404, which may be unique, in order to convert Clear Data 411 (i.e. unencrypted data) into Encrypted Data 412. The Encrypted Data 412 may be stored on a piece of backup media 413.

The Data Encryption Key 404 used to encrypt the Clear Data 411 may itself be encrypted before it is stored in a Header 414. For this purpose, a Reference Cryptographic Key 406 may be applied to a Key Encryption Algorithm module 410 to convert the Data Encryption Key 404 into an encrypted form for storage in Header 414. As an illustrative example, the Reference Cryptographic Key 406 may be a Key Encrypting Key or a Rivest, Shamir and Adleman (RSA) Public Key.

As shown in FIG. 4A, Reconstitution Data 408 containing data for reconstituting Encrypted Data 412 may be stored in Header 414 in an unencrypted form. The Reconstitution Data 408 may include, for example, a Reference Cryptographic Key Name corresponding to the Reference Cryptographic Key 406, Source Data Characteristics for the Clear Data 411, and Target Data Characteristics for the Encrypted Data 412. The Reference Cryptographic Key Name is stored in Header 414 in an unencrypted form, such that it may be used to retrieve the correct Reference Cryptographic Key 406.

The Reference Cryptographic Key 406 may have a naming convention corresponding to a file naming format for a particular client or particular purpose: e.g. “US.TO.CLIENT1.KEK” or “US.TO.ARCHIVE.RSA”. These file naming formats are illustrative only, and may serve to identify how and for whom the backup media was created. As an example, if a piece of backup media labelled “US.TO.ARCHIVE.KEK” and created in 2006 is sent to a storage repository “A”, then a Reference Cryptographic Key 404 may be made which references that storage repository for a particular year. Such a Reference Cryptographic Key 404 may be named, for example, “US.TO.ARCHIVE_A.KEY.2006”, and may be maintained in a centrally managed Cryptographic Reference Key Data Set 430. The Cryptographic Reference Key Data Set 430 may be secured using cryptographic hardware for an additional level of security.

At some point in the future, when backup data needs to be recovered, and backup media 413 is retrieved from a storage repository, the label “US.TO.ARCHIVE.KEK” and the Reference Cryptographic Key Name may be read directly from Header 414 of the backup media 413. The correct Reference Cryptographic Key 404, namely “US.TO.ARCHIVE_A.KEY.2006”, may then be retrieved from the Cryptographic Reference Key Data Set 430. As will be appreciated, maintaining relatively few Reference Cryptographic Keys 404 in a central and secure location may make it significantly easier to maintain and manage the Reference Cryptographic Keys 404 over an extended period of time.

Now referring to FIG. 4B, shown is a corresponding multi-level decryption system 400B having a Data Decryption Algorithm module 420 that may be used to decrypt the Encrypted Data 412 stored on the backup media 413 back into the Clear Data 411. However, before the Data Encryption Key 404 needed for the decryption may be used, the Data Encryption Key 404 needs to be retrieved from the Header 414 and decrypted.

The Reference Cryptographic Key Name, stored as part of the Reconstituting Data 408, may be read directly from the Header 414 without any need for decryption. Also, as discussed earlier, a naming convention for the backup media 413 stored at a particular storage repository may be chosen by the user to be meaningful and specific enough to identify the correct Reference Cryptographic Key 406 needed. Thus, for any piece of backup media 413 retrieved from a storage repository, the Encrypted Data 412 may be recovered as long as the Reference Cryptographic Key 406 named in the Header 414 still exists in the Central Reference Cryptographic Key Data Set 430.

Upon retrieving the correct Reference Cryptographic Key 406 from the Cryptographic Reference Key Data Set 430, the Reference Cryptographic Key 406 may be applied to Key Decryption Algorithm module 422 to retrieve and decrypt the Data Encryption Key 404 originally used to encrypt the Clear Data 411. The Cryptographic Reference Key Data Set 430 and Reference Cryptographic Key 406 may be stored in secure cryptographic hardware so that the Reference Cryptographic Key 406 may be used securely to decrypt the Data Encryption Key 404.

As will be appreciated, much of the relevant information necessary to reconstitute Encrypted Data may be stored directly on the backup media (i.e. as the Reconstitution Data 408) together with the Encrypted Data 412. The user need maintain only one or a few Reference Cryptographic Keys 406 that are associated with many pieces of backup media 413. With this approach, any Encrypted Data 412 may be stored with enough self-defining Reconstitution Data 408 such that, even years or decades into the future, the Encrypted Data 412 may be recovered from many pieces of backup media using a Reference Cryptographic Key that has been centrally maintained.

FIG. 5 shows an illustrative method 500 corresponding the system described above with reference to FIG. 4A. Method 500 begins, and at block 502 reads various encryption parameters as provided by a user. At block 504, method 500 encrypts clear data using a Data Encryption Key applied to a Data Encryption Algorithm. Method 500 then proceeds to block 506, where the Encrypted Data is stored onto a piece of backup media.

At block 508, method 500 encrypts the Data Encryption Key using a Reference Cryptographic Key applied to a Key Encryption Algorithm. Method 500 then proceeds to block 510, where the encrypted Data Encryption Key is stored in the header of the same piece of backup media as the Encrypted Data.

At block 512, method 500 stores the Reconstitution Data, including the Reference Cryptographic Key Name, in the backup media header. Method 500 then proceeds to block 514, where method 500 stores the Reference Cryptographic Key in a secure central location to use as necessary to decrypt the Encrypted Header at some point in the future. Method 500 then ends.

Now referring to FIG. 6, shown is a method 600 corresponding to the system described above with reference to FIG. 4B. Method 600 begins and at block 602 retrieves Reconstitution Data stored in the Header of a piece of backup media. At block 604, a Reference Cryptographic Key Name associated with the backup media is identified in the Reference Cryptographic Key Data Set.

At block 606, the correct Reference Cryptographic Key is applied to a Key Decryption Algorithm to decrypt the encrypted Data Encryption Key.

At block 608, method 600 applies the unique Data Encryption Key to a Decryption Algorithm to decrypt the Encrypted Data from the backup media, using the Reconstitution Data as may be necessary. Method 600 then ends.

While various illustrative embodiments of the invention have been described above, it will be appreciated by those skilled in the art that variations and modifications may be made. Thus, the scope of the invention is defined by the following claims.

What is claimed is:

1. A method of encrypting a file on backup media, comprising:
encrypting clear data using a data encryption key applied to a data encryption algorithm and outputting encrypted data;
storing the encrypted data on the backup media;
encrypting the data encryption key using a reference cryptographic key applied to a key encryption algorithm and outputting an encrypted data encryption key; and
storing the encrypted data encryption key and reconstitution data in a header of the backup media.

2. The method of claim 1, further comprising:
storing the reference cryptographic key in a reference cryptographic key data set.

3. The method of claim 2, further comprising:
storing in the reconstitution data the reference cryptographic key name.

4. The method of claim 3, further comprising:
storing in the reconstitution data the clear data characteristics and the encrypted data characteristics.

5. The method of claim 4, further comprising:
subsequently decrypting the encrypted data as follows:
reading the reference cryptographic key name from the reconstitution data;
identifying the reference cryptographic key in the reference cryptographic key data set using the reference cryptographic key name;
applying the reference cryptographic key to a key decryption algorithm to decrypt the encrypted data encryption key; and
applying the decrypted data encryption key to a data decryption algorithm to decrypt the encrypted data.

6. The method of claim 5, further comprising:
utilizing the clear data characteristics and the encrypted data characteristics stored in the reconstitution data to decrypt the encrypted data.

7. The method of claim 5, further comprising:
securing the reference cryptographic key in cryptographic hardware during decryption of the data encryption key.

8. A system for encrypting a file on backup media, comprising:
a data encryption algorithm module configured to encrypt clear data using a data encryption key and to output encrypted data;
encrypted data storing means for storing the encrypted data on the backup media;
a key encryption algorithm module configured to encrypt the data encryption key using a reference cryptographic key; and
header storing means for storing the encrypted data encryption key and reconstitution data in a header of the backup media.

9. The system of claim 8, further comprising:
a reference cryptographic key data set module for storing the reference cryptographic key.

10. The system of claim 9, wherein the storing means is configured to store the reference cryptographic key name in the reconstitution data.

11. The system of claim 10, wherein the storing means is configured to store the clear data characteristics and the encrypted data characteristics in the reconstitution data.

12. The system of claim 11, wherein the system is configured to subsequently decrypt the encrypted data, the system further comprising:
reading means for reading the reference cryptographic key name from the reconstitution data stored in the backup media header;
identifying means for identifying the reference cryptographic key in the reference cryptographic key data set using the reference cryptographic key name;
a key decryption algorithm module configured to decrypt the encrypted data encryption key by applying the reference cryptographic key; and
a data decryption algorithm module configured to decrypt the encrypted data by applying the decrypted data encryption key.

13. The system of claim 12, wherein the data decryption algorithm module is further configured to utilize the clear data characteristics and the encrypted data characteristics stored in the reconstitution data.

14. The system of claim 12, wherein the key decryption algorithm module is further configured to decrypt the data encryption key while securing the reference cryptographic key in the cryptographic hardware.

15. A data processor readable medium storing data processor code that when loaded into one or more data processors adapts the processors to provide a method for encrypting data on backup media, the data processor readable medium comprising:
code for encrypting clear data using a data encryption key applied to a data encryption algorithm and outputting encrypted data;
code for storing on the backup media;
code for encrypting the data encryption key using a reference cryptographic key applied to a key encryption algorithm and outputting an encrypted data encryption key;
code for storing the encrypted data, the encrypted data encryption key and reconstitution data in a header of the backup media.

16. The data processor readable medium of claim 15, further comprising:
code for storing the reference cryptographic key in a reference cryptographic key data set.

17. The data processor readable medium of claim 16, further comprising:
code for storing in the reconstitution data the reference cryptographic key name.

18. The data processor readable medium of claim 17, further comprising:
code for storing in the reconstitution data the clear data characteristics and the encrypted data characteristics.

19. The data processor readable medium of claim 18, further comprising:
code for subsequently decrypting the encrypted data, including:
code for reading the reference cryptographic key name from the reconstitution data;
code for identifying the reference cryptographic key in the reference cryptographic key data set using the reference cryptographic key name;
code for applying the reference cryptographic key to a key decryption algorithm to decrypt the encrypted data encryption key;
code for applying the decrypted data encryption key to a data decryption algorithm to decrypt the encrypted data.

20. The data processor readable medium of claim 19, further comprising:
code for utilizing the clear data characteristics and the encrypted data characteristics stored in the reconstitution data to decrypt the encrypted data.

21. The data processor readable medium of claim 19, further comprising:
code for securing the reference cryptographic key in cryptographic hardware during decryption of the data encryption key.
